(19) United States
(12) Patent Application Publication
(10) Pub. No.: US 2009/0215405 A1
(43) Pub. Date: Aug. 27, 2009

(54) Transceiver Antennae Arrangement

(75) Inventors: John Domokos, Hampshire (GB); David William Huish, Hampshire (GB); David Sherry, Hampshire (GB)

Correspondence Address: SIEMENS CORPORATION;INTELLECTUAL PROPERTY DEPARTMENT, 170 WOOD AVENUE SOUTH, ISELIN, NJ, 08830, US

(73) Assignee: ROKE MANOR RESEARCH LIMITED, Romsey, Hampshire (GB)

(21) Appl. No.: 11/920,673

(22) PCT Filed: Apr. 19, 2006
(86) PCT No.: PCT/EP2006/061662

§ 371 Date: Feb. 20, 2009

(30) Foreign Application Priority Data
May 19, 2005 (GB) 0510208.2

(51) Int. Cl. H04B 1/44

(52) U.S. Cl. 455/78

(57) ABSTRACT

An apparatus having a transmitter portion and a receiver portion each isolated from each other and comprising a plurality of antennae, each antenna being selectively connectable to both the receiver portion and transmitter portion, said antennae thus being common to both transmitter and receiver. It may be adapted such that one antenna is selectable to be used as a transmitter whilst at the same time an alternative antenna is selectable to be used as a receiving antenna.

### CROSS REFERENCE TO RELATED APPLICATIONS

This application is the US National Stage of International Application No. PCT/EP2006/061662, filed Apr. 19, 2006 and claims the benefit thereof. The International Application claims the benefits of British application No. 0510208.2 filed May 19, 2005, both of the applications are incorporated by reference herein in their entirety.

### FIELD OF INVENTION

This invention relates to transceivers and has particular but not exclusive applications to transceivers which transmit signals and also receives the reflected signals therefrom or receives signals wherein the transmitted signal has been modulated by a passive object such as a tag.

### BACKGROUND OF INVENTION

Radio frequency identification devices (RFIDs) are passive devices, also known as tags, which are used for identification purposes. They may be located on items such as consumer goods. RFID systems typically comprise a reader which comprises a transmitter and receiver, and one or more antennas to transmit and receive signals from the tag.

In passive RFID systems the tag is energised by the reader, typically by a continuous wave (CW) RF field transmitted via an antenna of the reader. The reader to tag communication is arranged by modulating the CW signal. The tag decodes this and responds by back scattering the transmitted CW. The back scattered signals is received by an antenna and decoded in the receiver.

In a typical system the power of the transmitted signal is in the order of 100 mW-2 W and the back scattered signal is recovered with a homodyne receiver. The received signal is very weak, in the order of 1 nW-100 nW depending on the distance between the reader and the tag.

FIG. 1 shows a prior art arrangement of a typical reader. In this example four antenna A, B, C and D are used to interrogate the tag. It includes a transmitter 3 and receiver 2. If the path from antenna A to the tag is obstructed (or impaired by multi-path propagation) the switch selects antenna B. For example if the reader is located on a fork lift truck the antennae may be located at various points on the truck and antennae proximal to the tag may have better transmission/reception than those antenna distal thereto. The switch 1 cycles through all antennae until the communication between the reader and the tag has been successfully completed.

The problem with this arrangement is that the receiver 2 is desensitised by the transmitted (own) signal. This signal leaks through the circulator P1 because of the finite isolation of a practical device. Furthermore some of the transmitted signal is reflected back from the antenna because of the return loss limitation of the antenna and cabling. The transmitter receiver isolation (sum of P1 and P2) is in the order of 15-25 dB; this limits the reading range of this type of reader to about 1-3 m.

A known improvement is to isolate the transmitter and receiver. Such an arrangement is shown schematically in FIG. 2. In this example there are separate antennae for the transmitter and the receiver and thus the aforementioned desensitisation problem is greatly reduced. The isolation (P3) is typically 30-40 dB which means that typically the reading range is increased to 3 to 10 m. The disadvantage with such a system is that twice as many antennae are required. This means that the hardware and the installation costs of this system are higher.

### SUMMARY OF INVENTION

It is an object of the invention to provide for transceiver means having effective isolation and which reduces the inherent cost of prior art solutions.

The invention will now be described by way of example shown in FIG. 3.

### BRIEF DESCRIPTION OF THE DRAWINGS

FIG. 1 shows a prior art arrangement of a typical reader.

FIG. 2 shows separate antennae for a transmitter and a receiver.

FIG. 3 shows a basic embodiment of a reader comprising a transmitter and a receiver both if which are connectable to a plurality of antennae

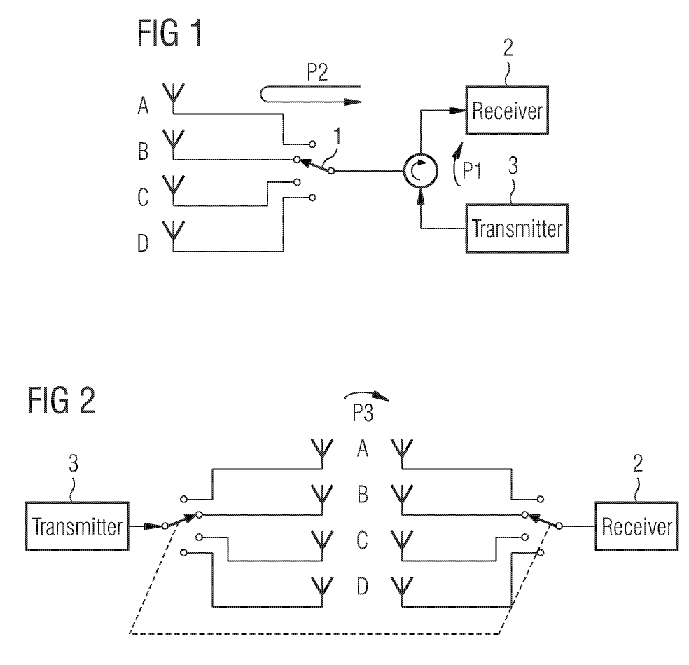

### DETAILED DESCRIPTION OF INVENTION

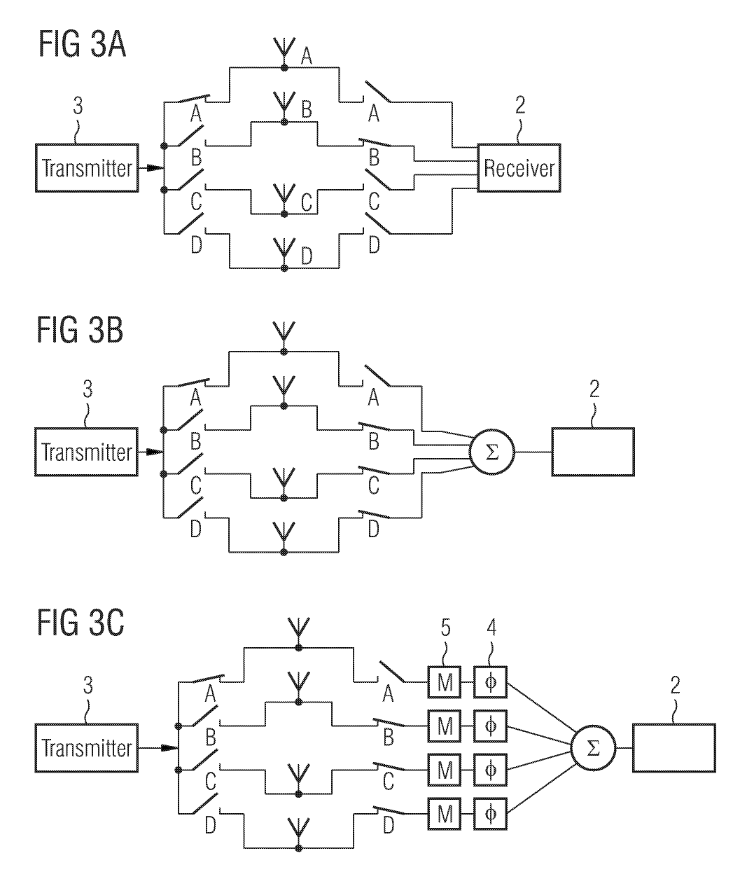

FIG. 3 shows a basic embodiment of a reader 1 comprising a transmitter 2 and a receiver 3 both if which are connectable to a plurality of antennae A, B C D by means of a switching matrix 5. In general there are N antennae, where N=4, all of which can be used as a transmitting or receiving antenna.

In a basic embodiment of the operation of such a system, one antenna at a time is used for transmission and the switch matrix permits all the remaining antennas to be used as receivers. Having separate antenna for transmitting and receiving at any one time ensures high isolation, in a similar way to the FIG. 2 prior art embodiment. Thus if antenna A is being used to transmit, any of the antenna B C or D may be used to receive.

In a further variation in methodology more than one antenna may be used to receive the signal. If in the apparatus and example of FIG. 3a, antenna A is being used as the transmitting antenna, then antenna B is used to receive.

Any combination of transmitters B, C or D may be used. For example B+C or B+D or C+D. Additional all the antenna B+C+D may be used to receive the signal. The signals coming into the receiving unit from all antennae B C & D are effectively summed; this is shown schematically in FIG. 3a. FIG. 3b shows such an enhanced system of the invention where the receiving antennas are summed before being fed into the receiving unit.

FIG. 3c shows a further refined embodiment of the invention. A drawback of the FIG. 3b arrangement is that although unlikely, it may be that occasionally the signals received at the antennae may be out of phase and/or have different strength. This may lead to the signals cancelling each other out to a certain extent. In a preferred embodiment the signals of the antenna used for receiving are combined coherently. By is meant the received signals from the antenna are rotated in phase so as to make sure they are all in the same phase by phase rectification units 4. Additionally the magnitudes of the signals are amplified by an appropriate scaling factors (amplifiers 5) to ensure that they each have equal weighting.

1.-12. (canceled)

13. An apparatus, comprising:
a transmitter portion;
a receiver portion;
a switching matrix;
a plurality of antennas, wherein each antenna is selectively connectable via the switching matrix to both the receiver portion and the transmitter portion, wherein when one or more of the plurality of antennas is connected to the transmitter portion as a transmitting antenna, any one of the remaining antennas of the plurality of antennas are connected to the receiver portion as receiving antennas.

14. The Apparatus as claimed in claim 13, wherein the plurality of antennas comprise four antennas.

15. The Apparatus as claimed in claim 13, wherein at least two antennas are transmitting antennas.

16. The Apparatus as claimed in claim 15, wherein at least two antennas are receiving antennas.

17. The Apparatus as claimed in claim 13, wherein at least one antenna is a transmitting antenna and all of the remaining antennas are receiving antennas.

18. The Apparatus as claimed in claim 13, wherein the output of the receiving antennas is summed to a receiving unit.

19. The Apparatus as claimed in claim 13, wherein the apparatus further comprises phase rectification units.

20. The Apparatus as claimed in claim 19, wherein the rectification units ensure that all the signals from the antennas are in phase.

21. The Apparatus as claimed in claim 20, further comprising scaling units to scale the signals from the antennas.

22. The Apparatus as claimed in claim 21, wherein the scaled signals are of the same signal strength.

23. A method of transmitting and receiving signals, comprising:
providing a transceiver having isolated receiver and transmitter portions;
transmitting a signal via a first antenna; and
receiving a signal via a second antenna, wherein the first antenna and the second antenna are selectively connectable to the transmitter portions or to the receiver portions via a switching matrix.

24. The method as claimed in claim 23, wherein the received signal is a reflection of the transmitted signal.

25. The method as claimed in claim 23, wherein the received signal is the transmitted signal modulated.

26. The method as claimed in claim 24, wherein the received signal is also the transmitted signal modulated.

27. The method as claimed in claim 23, wherein a plurality of antennas are used to transmit or receive the signals.

28. The method as claimed in claim 27, wherein the received signals are summed.

29. The method as claimed in claim 27, wherein the received signals are scaled.

30. The method as claimed in claim 27, wherein the received signals are phase shifted to ensure that they are in the same phase.

31. A method of identifying a tag, comprising:
providing a transceiver with isolated receiver and transmitter portions;
transmitting a signal via at least one first antenna;
receiving a signal from a second antenna, wherein the first antenna and the second antenna are selectively connectable by said transmitter or receiver portions via a switching matrix.

32. The method as claimed in claim 31, wherein a plurality of antennas are used to transmit or receive the signals, wherein the received signals are summed, wherein the received signals are scaled, and wherein the received signals are phase shifted.
